(19) United States
(12) Patent Application Publication
(10) Pub. No.: US 2021/0078230 A1
(43) Pub. Date: Mar. 18, 2021

(54) PLASTICIZING CYLINDER OF A PLASTIC EXTRUDER OR AN INJECTION MOLDING MACHINE

(71) Applicant: inmex GmbH, Sankt Augustin (DE)

(72) Inventor: Axel IFLAND, Sankt Augustin (DE)

(73) Assignee: inmex GmbH, Sankt Augustin (DE)

(21) Appl. No.: 17/106,886

(22) Filed: Nov. 30, 2020

Related U.S. Application Data
(63) Continuation of application No. PCT/EP2019/061438, filed on May 3, 2019.

(30) Foreign Application Priority Data
May 30, 2018 (DE) 102018112939.4

(51) Int. Cl. B29C 45/74; B29C 45/62; B29C 48/80; B29C 48/68; B29C 48/875

(52) U.S. Cl. CPC B29C 45/74; B29C 45/62; B29C 48/875; B29C 48/834; B29C 48/68; B29C 48/832

(57) ABSTRACT

A barrel of a plastics extruder or a plasticizing cylinder of an injection-molding machine includes the barrel or cylinder having a wall, at least one spiral recess formed in the wall, and at least one heating element arranged in one spiral recess. The barrel or cylinder has at least one cooling element arranged in another spiral recess and the spiral recesses extend parallel to one another along the surface of the barrel or cylinder. Also, the cooling element is formed as a tube and the tube is or can have a liquid cooling medium flowing therethrough.

### CROSS-REFERENCE TO RELATED APPLICATIONS

This application claims priority to and the benefit of PCT/EP2019/061438, filed on May 3, 2019, which claims priority to and the benefit of DE 102018112939.4, filed on May 30, 2018. The disclosures of the above applications are incorporated herein by reference.

### FIELD

The present disclosure relates to a plasticizing cylinder of a plastic extruder or an injection molding machine.

### BACKGROUND

The statements in this section merely provide background information related to the present disclosure and may not constitute prior art.

Plastic extrusion as a primary forming process is very energy consuming. The plastic granulate to be processed has to be melted first in order to be extruded in a forming process. In this melting process, which is also called a plasticizing process, the granulate is fed into a plasticizing cylinder. The plasticizing cylinder is formed as a hollow cylinder.

It is known to heat the plasticizing cylinder from the outside via half-shell-shaped heating pads. Inside the plasticizing cylinder a screw conveyor is arranged. By turning the screw conveyor, the screw conveys the granulate through the interior of the hollow cylinder, wherein the plastic is melted to a fluid mass. This mass is mixed and homogenized by the screw conveyor as it rotates, before it is continuously dispensed via a shape-forming tool. Due to the friction between the screw conveyor and the plastic, additional energy or heat is introduced into the plastic. This is known as frictional energy.

Depending on the sensitivity of the plastic, the screw speed and the geometry, it is not uncommon in the ongoing process for the heating pads to be no longer needed in certain zones to heat the plastic. The dissipative heat input of the screw conveyor is sufficient to heat the plastic. In these cases, however, temperature control of the process is difficult and overtemperature (i.e., an overshoot greater than or above a set temperature) can occur. In order to be able to cool the cylinder back to the set temperature, each heating zone is equipped with a housing and a ventilation fan. If the temperature rises above the set point, the fan can be used to counteract this. In many cases there are additional cooling elements on the surface of the heating pads to make the cooling more efficient. However, cooling down the plasticizing cylinder is equivalent to high energy losses. Not only does the heat that has already been introduced have to be dissipated again in the event of an overtemperature, the heating pads, which are ribbed on the surface, release heat to the environment via radiation and convection in an operating state even without an overtemperature event occurring. An enclosure made of sheet metal hardly alters or corrects this situation.

A reasonable measure to reduce these heat losses would be a cylinder insulation as used in injection molding plasticizing units. This is, however, only insufficiently applicable to extruders of this type, as air needs to be able to flow around the heating pad. Furthermore, air cooling is very inefficient. Although air is a very inexpensive cooling medium, it is also a poor heat carrier. In addition, it takes a while until the cooling effect actually reaches the plastic via the heating pads and the cylinder, which makes temperature control more difficult.

In addition to the standard system described above, there are other variants for extruder temperature control that deviate from it. For example, there are plasticizing cylinders with a square cross-section that are heated by heating cartridges inserted at the sides. The cylinder is cooled with water, which can run through bores in the cylinder.

It is known to form cylinders with spiral-shaped recesses, which are sealed to the outside by heating shells mounted in a form-fitting manner and through which a liquid cooling medium flows. It is also known to form the spiral-shaped recess also on the inner surface of the heating shells, wherein the half-shells are then fitted sealingly around the cylinder.

From DD 111 843 A1 a temperature controlled cylinder for plastic processing machines, especially for extruders, is known. Narrow heating pads and cooling rings for a liquid coolant, divided into a number of control zones, are arranged one behind the other in the axial direction on the cylinder. The width of the heating pads corresponds approximately to the width of the cooling rings, so that the heating pads can be exchanged for cooling rings. A cooling ring consists of two half-shells, which have an inner casing, a coolant chamber and an outer casing. The coolant chamber is closed on both sides with blind flanges and elastic clamping elements are arranged on the blind flanges to hold the cooling ring.

A single-screw extruder is known from DE 42 26 350 A1. The single-screw extruder has a tubular grooved bush shrink-fitted into a pressure-resistant reinforcement in a feed section. To increase its efficiency, a cooling channel is formed on the outer casing of the reinforcement. The cooling channel in the reinforcement is surrounded by a sealing cover consisting of two detachably connected half-shells. On their outer surface, the reinforcements have helical channels through which sequentially cooling water flows.

From DE 20 2014 003 691 U1 a device for tempering cylinders for processing plastics or other plastic materials is known. The cylinder wall has longitudinal bores which are filled with a liquid. This liquid coolant flows through the axial cylinder bores.

From U.S. Pat. No. 2,721,729 a cylinder for an extruder is known, which has a spiral groove on its outside. Elongated heating elements are arranged in the groove. A sleeve is attached to the outer circumferential surface. Together with the groove and the heating elements, the sleeve defines a remaining groove space through which a coolant flows.

A plasticizing cylinder with a spiral groove on the outer surface is known from U.S. Pat. No. 2,522,365. A conduit in the form of a copper tube is arranged in the groove, through which a heat transfer medium (oil, water, gas or steam) is passed.

From WO 01/14121 A1 a barrel for a twin screw extruder is known. A number of channels are formed on the outside of the barrel, which extend equidistantly in a helical pattern. A hollow sleeve is inserted onto the cylinder to seal the channels. In these channels exactly one tempering medium is used.

From DE 27 56572 A1 a cooling-heating device in the screw housing of a screw machine is known. A wear insert is arranged in the screw housing. Between an outer surface of the wear insert and a recess of the screw housing a space is formed in which the cooling-heating device is arranged. This cooling-heating device consists of a tube that is helically wound onto the wear insert. The ends of the tube are connected to a fluid inlet channel and a fluid outlet channel. The tube is used to transport a tempering medium, especially for the passage of cooling water. However, hot water can also be passed through the tube if heating is desired. This means that there are no separate heating and cooling elements, but only one tube, which can be used alternatingly for heating or cooling. The space between the turns of the tube is filled with a hardening material. Furthermore, in the helical area between the windings of the tube, an electric heater in the form of heating wire coils can be arranged. This arrangement has the disadvantage that the arrangement is complex to manufacture. As soon as one element is defective, the entire cooling-heating system has to be replaced.

### SUMMARY

This section provides a general summary of the disclosure and is not a comprehensive disclosure of its full scope or all of its features.

The teachings of the present disclosure provides an improved plasticizing cylinder and in particular provides an energy-efficient plasticizing system for extruders or injection molding machines.

In some variations, the improved plasticizing cylinder has at least two recesses on its surface, wherein the recesses extend spirally and parallel to one another, wherein at least one heating element is arranged in one recess, wherein at least one cooling element is arranged in another spiral recess, wherein the spiral recesses extend parallel to one another along the surface of the plasticizing cylinder, wherein the at least one cooling element is a tube, wherein a liquid cooling medium flows or can flow through the tube. In some variations, on the outer side of the wall around the at least one cooling element and at least one heating element there is arranged at least one insulating sleeve, and in at least one variation there is arranged a plurality of insulating sleeves.

In particular, there may be two recesses. The recesses form in particular a double spiral. It is also conceivable to provide three or more than three recesses. In this case, the recesses form a multiple spiral, whereby the first recess, the second recess, the third recess, etc. are arranged next to each other in the axial direction. The spirals formed by the recesses intermesh. At least one heating element is arranged in a recess.

At least one cooling element is arranged in another spiral-shaped recess, whereby the spiral-shaped recesses extend parallel to each other along the surface of the plasticizing cylinder. In the first recess at least one elongated heating element is arranged and in the second recess at least one elongated cooling element is arranged. This makes it possible to significantly reduce the heat losses and thus the heating energy requirement.

The cooling elements and/or the heating elements are adapted to the cross section of the recesses, whereby the heating elements and/or the cooling elements are in contact with both the bottom and the sides of the recesses. The elongated heating element is especially provided as a heating cartridge with a square cross-section. In some variations, the recesses also have a rectangular cross-section and in at least one variation the recesses have a square cross-section. In some variations, the recesses are milled into the wall.

The cooling elements are provided in the form of tubes, for example copper tubes, wherein the tubes (e.g., copper tubes) are pressed into the corresponding recess. It is also possible to use tubes for the heating elements, e.g., steel tubes or copper tubes. The cooling element can be a copper tube, through which water or another liquid cooling medium such as oil flows. Alternatively, a steel tube can be used for the cooling elements.

In some variations, the plasticizing cylinder has several zones adjacent to each other in the axial direction. In each zone at least one separate cooling element and/or one separate heating element can be arranged. The cooling elements and/or the heating elements can be controlled and/or closed loop controlled separately for each zone. In some variations, exactly one heating element and exactly one cooling element are arranged in each zone. It is conceivable that each zone has a separate double spiral with two recesses or a multiple spiral with three or more recesses. In at least one variation, however, exactly one double spiral with two recesses or exactly one multiple spiral with three or more recesses is provided, wherein these can be controlled zone by zone by heating and/or cooling elements that can be controlled separately or in groups.

In some variations, a plurality of recesses are arranged parallel to each other, so that each zone can also be equipped with multiple heating elements. For example, if there are three recesses a plurality of heating elements can be arranged in each of the first and the second recesses and a plurality of cooling elements can be arranged in the third recess.

In at least one variation, at least one of the zones only comprises at least one heating element, but no cooling elements. The plasticizing cylinder thus has at least one zone with both at least one cooling element and at least one heating element and in addition at least one adjacent zone with only at least one heating element without cooling elements. The recess for the at least one cooling element does not extend across all zones, but only across the zones with cooling element and heating element. In such variations, installation space is saved or reduced.

The plasticizing cylinder according to the teachings of the present disclosure improves the energy efficiency of the cylinder temperature control, as the inserted heating elements can transfer the generated heat to the cylinder via three quarters (¾) of their surface. Thus, the embedded heating element improves the heat transfer considerably. Likewise, the cooling elements, i.e., the cooling tubes, inserted parallel to the heating elements very effectively dissipate excess heat via the liquid cooling medium. If an overtemperature occurs, the cooling water flow is controlled by an upstream valve. This system is more efficient than the air cooling used in conventional systems. By embedding the elements into the plasticizing cylinder, it is possible to react much faster to external influences.

Another advantage of this system is that in some variations the plasticizing cylinder is insulated, thus reducing waste heat losses. For insulation purposes, the plasticizing cylinder can be encased in at least one, and in some variations multiple, insulation sleeves. On the outer surface of the wall surrounding the cooling elements and the heating elements there is at least one, and in some variations multiple insulation sleeves.

The plasticizing cylinder can be used in a plastic extruder, for example a single-screw extruder, a twin-screw extruder or a degassing extruder with a screw of constant or conical diameter.

In the thermoplastic injection molding process there is no requirement to cool the plasticizing cylinder during the production process. However, cooling the plasticizing cylinder of an injection molding machine is still beneficial if, for example, the temperature of the plasticizing cylinder needs to be lowered for material changing. For example, and assuming the user operates the injection molding machine with material A at a cylinder temperature of 300° C., the user can desire to process material B at 200° C. Due to the cylinder insulation according to the teachings of the present disclosure, the cylinder cools down very slowly. In addition to the “heating groove”, a “cooling groove” is made into the cylinder in phases, into which a tube, for example a copper tube, is embedded. The number of windings, zones and lengths are dependent on the space available. This allows the user to manually allow an inflow of cooling medium, for example water, during the material change, which cools the unit via the cooling tubes significantly faster than conventionally possible. The cooling is even faster than without insulation. This type of cooling therefore represents a so-called rapid cooling.

The plasticizing cylinder can be cooled while the mold is being changed over for the subsequent application, which saves time here.

As a standard feature, every injection molding machine is equipped with a feed zone cooling system, which is also available for the plasticizing cylinder according to the present disclosure and cannot be compared to a rapid cooling system. The feed zone cooling takes place only in the feed section of the plasticizing cylinder and is intended to provide that the material does not melt prematurely and can be easily received by the screw. Cooling according to the teachings of the present disclosure, on the other hand, takes place zone by zone of the cylinder. In particular, the grooves milled for this purpose are only provided per zone within the insulation sleeve.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows in a schematic, perspective view a plasticizing cylinder;

FIG. 2 shows in a schematic longitudinal sectional view the plasticizing cylinder in FIG. 1; and

FIG. 3 shows in a schematic longitudinal sectional view of the plasticizing cylinder in FIG. 2 with additional insulating sleeves.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

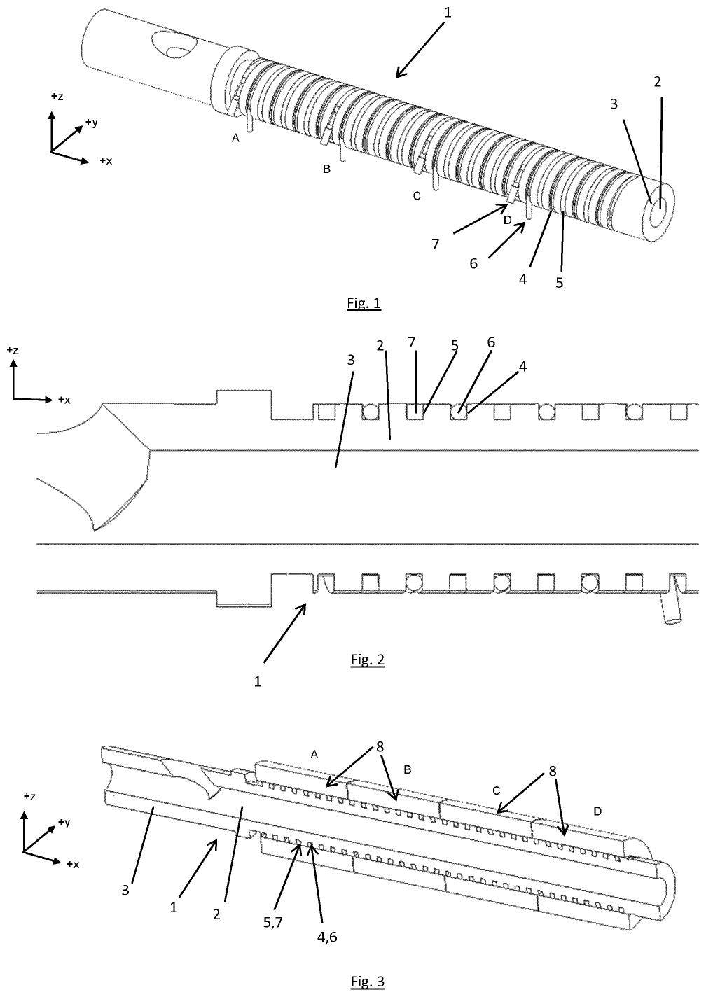

Referring to FIGS. 1, 2 and 3, a plasticizing cylinder 1 is shown. The plasticizing cylinder 1 has a hollow cylindrical configuration and an internal space 2 defined by the plasticizing cylinder 1 where a screw of an extruder is arranged. Non-limiting examples of an extruder include a single screw extruder, a plastic extruder, a twin screw extruder, a degassing extruder, a screw with constant or conical diameter, among others. In the illustrated implementation the internal space 2 is hollow cylindrical. The plasticizing cylinder 1 comprises a wall 3, which delimits the internal space 2.

As shown in FIGS. 1-3, a number of spiral-shaped recesses 4, 5 are arranged on an outer surface of the wall 3. In particular, two spiral-shaped recesses 4, 5 are formed on the outer (+/−z direction) surface of the wall 3. The two recesses 4, 5 run parallel to each other, so that in the longitudinal sectional view according to FIG. 2, the first recess 4 and the second recess 5 are arranged adjacent to each other in the longitudinal direction (x direction). In some variations the first recess 4 is located exactly in the middle between two adjacent second recesses 5, so that the distance between the recesses 4, 5 is constant.

In the first recess 4 there is arranged at least one cooling element 6 and in the second recess 5 at least one heating element 7. It is conceivable to arrange more than one heating element 7 and/or more than one cooling element each distributed in different zones in order to further improve the temperature control. Accordingly, an energy-efficient plasticizing system for extruders is provided and waste heat losses are reduced. This also significantly reduces the heating energy requirement, i.e., the heating energy need to desirably heat the plasticizing cylinder 1. This is achieved by the fact that plasticizing cylinder 1 has at least two spiral-shaped recesses 4, 5 on its surface.

In some variations, the recesses 4, 5 have a rectangular cross-section. The heating elements 7 have a rectangular cross-section adapted to the recesses 5. The heating elements 7 are provided as heating cartridges with a rectangular, e.g., square cross-section, wherein the heating cartridges 7 each have an electrical resistance heating element (not shown) and provide electrical resistance heating.

In at least one variation, the cooling element 6 is a copper tube pressed into the recess 4. It is conceivable that several cartridge heaters can be embedded per heating zone (not labeled) along the longitudinal direction (x direction) of the plasticizing cylinder 1. The energy efficiency of controlling the temperature of the plasticizing cylinder 1 is improved, since the embedded heating elements 7 can emit heat to the plasticizing cylinder 1, especially via ¾ of their surface. That is, three sides of the four-sided heating elements 7 are in contact with the plasticizing cylinder 1 and thereby three sides % of the four-side heating elements provide or emit heat to the plasticizing cylinder 1. Accordingly, it should be understood that the cross-section of the heating elements 7 is adapted to the cross-section of the recess 5.

In some variations, the cross-section of the cooling elements 6 is also adapted to the cross-section of the recess 4. The cooling tubes embedded parallel to the heating elements 7 effectively dissipate excess heat via a liquid medium (not labeled) flowing through the cooling elements 6. The liquid medium can be water or oil, among others.

The plasticizing cylinder 1 has a plurality of axially adjacent zones (e.g., a plurality of axially adjacent heat zones), wherein at least one heating element 7 and/or at least one cooling element 6 is arranged in each zone, and wherein the heating elements 7 and/or the cooling elements 6 can be controlled and/or closed loop controlled separately for each zone. As shown in FIG. 1, there are four zones A-D, each with one heating element 7 and one cooling element 6.

If an overtemperature occurs, cooling liquid medium is controlled by an upstream valve (not shown). This system is significantly more efficient than the more inert air cooling used currently. By integrating the cooling elements 6 and the heating elements 7 into the plasticizing cylinder 1, it is possible to react considerably faster, i.e., within a shorter time frame, to external influences.

Another advantage of this system is that the plasticizing cylinder 1 can be insulated by means of multiple insulation sleeves 8 a shown in FIG. 3. In some variations, there is one insulation sleeve 8 per zone A-D. An advantage here is the combination of the heating of a plasticizing cylinder 1 in a spiral groove, i.e., the heating cartridges embedded in the recess 5, in combination with the spirally-formed copper tubes embedded in the recesses 4, i.e., the cooling elements 6.

### LIST OF REFERENCE SYMBOLS

1 Plasticizing cylinder
2 Internal space
3 Wall
4 Recess
5 Recess
6 Cooling element
7 Heating element
8 Insulation sleeve

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A plasticizing cylinder of a plastic extruder or an injection molding machine, the plasticizing cylinder comprising:
a wall with at least one first recess and at least one second recess formed in the wall, wherein the at least one first recess and the at least one second recess are spiral shaped and extend parallel to one another along an outer surface of the wall; and
at least one heating element arranged in the at least one first recess and at least one cooling element arranged in the at least one second recess, wherein the cooling element is a tube configured for a liquid cooling medium to flow therethrough.

2. The plasticizing cylinder according to claim 1, wherein the tube is pressed into the at least one second recess.

3. The plasticizing cylinder according to claim 1, wherein a plurality of heating elements are arranged in the at least one first recess and a plurality of cooling elements are arranged in the at least one second recess, the wall comprises a plurality of axially adjacent zones, wherein in each of the plurality of axially adjacent zones at least one heating element or at least one cooling element is arranged, and the plurality of heating elements and the plurality of cooling elements are separately controlled zone by zone.

4. The plasticizing cylinder according to claim 3, wherein in at least one of the plurality of axially adjacent zones both a cooling element and a heating element are arranged and in at least one adjacent zone to the at least one of the plurality of axially adjacent zones at least one heating element is arranged but a cooling element is not arranged.

5. The plasticizing cylinder according to claim 1, wherein the cooling elements is shaped to fit a cross-section of the at least one second recess and the heating element is shaped to fit a cross-section of the at least one first recess, wherein the heating element is in contact with a bottom and sidewalls of the at least one first recess.

6. The plasticizing cylinder according to one claim 1, wherein the at least one first recess and the at least one second recess have a rectangular cross-section.

7. The plasticizing cylinder according to claim 6, wherein the heating element has a rectangular cross-section shaped to fit the at least one first recess.

8. The plasticizing cylinder according to claim 6, wherein the cooling element has a round cross-section.

9. The plasticizing cylinder according to claim 1, wherein the at least one first recess and the at least one second recess are milled into the wall.

10. The plasticizing cylinder according to claim 1, wherein the heating element is provided as a heating cartridge, the heating cartridge being an electric resistance heating cartridge.

11. The plasticizing cylinder according to claim 1, wherein at least one insulating sleeve is arranged on the outside of the wall, the at least one insulating sleeve being arranged around the at least one cooling element and the at least one heating element.

12. A plasticizing cylinder with a wall, at least one first recess and at least one second recess being formed in said wall, wherein the at least one first recess and the at least one second recess are spiral-shaped and extend parallel to one another along an outer surface of the wall, at least one heating element being arranged in the at least one first recess and at least one cooling element being arranged in the at least one second recess, wherein the cooling element is a tube configured for a liquid cooling medium to flow therethrough, wherein the at least one first recess and the at least one second recess have a rectangular cross-section, and wherein the at least one heating element has a rectangular cross-section shaped to fit the at least one first recess.

13. The plasticizing cylinder according to claim 12, wherein a plurality of heating elements are arranged in the at least one first recess and a plurality of cooling elements are arranged in the at least one second recess, the wall comprises a plurality of axially adjacent zones, wherein in each of the plurality of axially adjacent zones at least one heating element or at least one cooling element is arranged, and the plurality heating elements and the plurality cooling elements are separately controlled zone by zone.

14. The plasticizing cylinder according to claim 13, wherein in at least one of the plurality of axially adjacent zones both a cooling element and a heating element are arranged and in at least one adjacent zone to the at least one of the plurality of axially adjacent zones at least one heating element is arranged but a cooling element is not arranged.

15. The plasticizing cylinder according to claim 12, wherein the at least one first recess and the at least one second recess are milled into the wall.

16. The plasticizing cylinder according to claim 12, wherein the at least one heating element is provided as at least one heating cartridge and the at least one heating cartridge is at least one electric resistance heating cartridge.

17. The plasticizing cylinder according to claim 12 further comprising at least one insulating sleeve arranged on the outside of the wall around the at least one cooling element and the at least one heating element.

18. A plasticizing cylinder with a wall, at least one first recess and at least one second recess being formed in said wall, wherein the at least one first recess and the at least one second recess are spiral-shaped and extend parallel to one another along an outer surface of the wall, at least one heating element being arranged in the at least one first recess and at least on cooling element being arranged in the at least one second recess, wherein the cooling element is a tube configured for a liquid cooling medium to flow therethrough, wherein a plurality of heating elements are arranged in the at least one first recess and a plurality of cooling elements are arranged in the at least one second recess, the wall comprises a plurality of axially adjacent zones, wherein in at least one of the plurality of axially adjacent zones a cooling element and a heating element are arranged, and wherein in at least one adjacent zone to the at least one of the plurality of axially adjacent with the cooling element and the heating element arranged therein at least one heating element is arranged and a cooling element is not arranged.

19. The plasticizing cylinder according to claim 18, wherein the at least one first recess and the at least one second recess are milled into the wall, and the at least one heating element is at least one electric resistance heating cartridge.

20. The plasticizing cylinder according to claim 18 further comprising at least one insulating sleeve arranged on the outside of the wall around the at least one cooling element and the at least one heating element.
